(19) United States
(12) Patent Application Publication
(10) Pub. No.: US 2006/0200813 A1
(43) Pub. Date: Sep. 7, 2006

(54) FIRMWARE UPDATING SYSTEM

(76) Inventors: Sea-Weng Young, Ping-Tung Hsien (TW); Peter Liu, Taipei City (TW); Wen-Hsiang Chang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/906,657

(22) Filed: Mar. 1, 2005

(51) Int. Cl. G06F 9/44

(52) U.S. Cl. 717/168

(57) ABSTRACT

A method of updating firmware of a circuit module includes providing a switch for selectively connecting the circuit module to a computing system and an update module. The circuit module enters a reset mode and an input/output pin of the circuit module switches to an input mode in response to power being supplied to the circuit module. The input/output pin is pulled to a first digital logic value, which controls the switch to connect the circuit module to the update module. While the circuit module is in the reset mode, the circuit module receives updated firmware from the update module. Then the circuit module enters a normal operation mode and switches the input/output pin to an output mode for outputting a second digital logic value. When the input/output pin outputs the second digital logic value, the input/output pin controls the switch to connect the circuit module to the computing system.

### BACKGROUND OF INVENTION

1. Field of the Invention

The present invention relates to a system for updating firmware, and more specifically, to a firmware updating system utilizing a single GPIO pin to switch connection of a circuit module to either a computing system or to an update module for updating the firmware of the circuit module without utilizing the computing system.

2. Description of the Prior Art

When developing and testing a circuit module that interacts with a computing system, the firmware of the circuit module often has to be updated. These updates are necessary for testing new features and fixes to the firmware of the circuit module. Unfortunately, the circuit module often only has one data bus, and that data bus is used for communicating with the computing system. In this case, the updated firmware must be transmitted to the circuit module through the computing system. Relying on the computing system for updating the firmware of the circuit module complicates the updating process by involving extra hardware that must be understood and configured so that the update can take place.

### SUMMARY OF INVENTION

It is therefore an objective of the claimed invention to provide a method for updating firmware of a circuit module in order to solve the above-mentioned problems.

According to the claimed invention, a method of updating firmware of a circuit module includes providing a switch for selectively connecting the circuit module to a computing system and to an update module, supplying power to the circuit module, and the circuit module entering a reset mode and an input/output pin of the circuit module switching to an input mode in response to power being supplied to the circuit module. The input/output pin is pulled to a first digital logic value, and the input/output pin controls the switch to connect the circuit module to the update module in response to the input/output pin being pulled to the first digital logic value. While the circuit module is in the reset mode, the circuit module receives an updated firmware from the update module. Then the circuit module enters a normal operation mode and switches the input/output pin to an output mode for outputting a second digital logic value in response to the circuit module receiving all updated firmware from the update module, the second digital logic value being the opposite of the first digital logic value. When the input/output pin outputs the second digital logic value, the input/output pin controls the switch to connect the circuit module to the computing system.

It is an advantage of the claimed invention that the input/output pin controls the switch to connect the circuit module to either the computing system or to the update module. In this way, the firmware of the circuit module can be updated without having to transmit the firmware through the computing system.

These and other objectives of the claimed invention will no doubt become obvious to those of ordinary skill in the art after reading the following detailed description of the preferred embodiment, which is illustrated in the figure below.

### BRIEF DESCRIPTION OF DRAWINGS

FIG. 1 is a functional block diagram of a development system according to the present invention.

### DETAILED DESCRIPTION

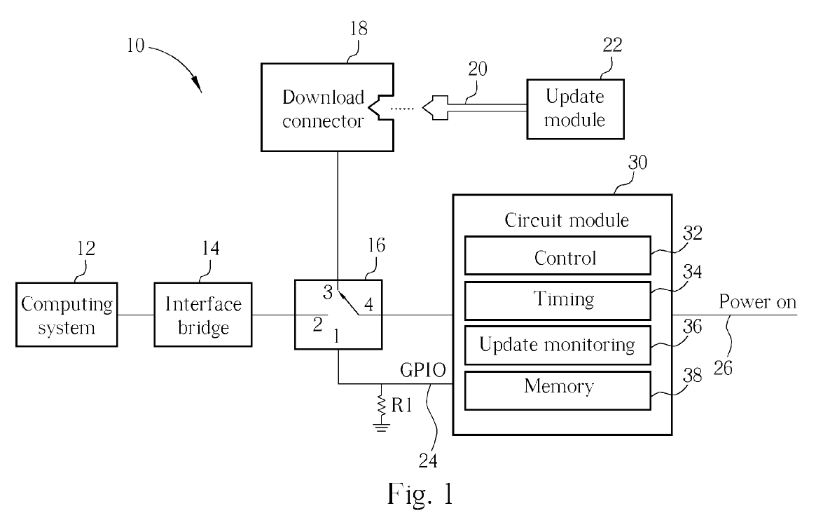

Please refer to FIG. 1. FIG. 1 is a functional block diagram of a development system 10 according to the present invention. The development system 10 contains a circuit module 30. The circuit module 30 contains a memory 38 that is used for storing firmware of the circuit module 30. The development system 10 is used for testing the circuit module 30 that operates in conjunction with a computing system 12. The circuit module 30 can be any kind of device that uses firmware or software that can be updated. One example of this would be a global system for mobile communications/general packet radio service (GSM/GPRS) module, although this is by no means limiting.

The circuit module 30 is connected to a switch 16 at port 4 of the switch 16. A general purpose input/output (GPIO) pin 24 of the circuit module 30 is connected to port 1 of the switch 16 to act as a selection control for the switch 16. When the digital logic value of the GPIO pin 24 is equal to “1”, ports 2 and 4 of the switch 16 are connected. In other words, the circuit module 30 is connected to the computing system 12. On the other hand, when the digital logic value of the GPIO pin 24 is equal to “0”, ports 3 and 4 of the switch 16 are connected, and the circuit module 30 is connected to a download connector 18. A cable 20 of an update module 22 is connected to the download connector 18 when the firmware stored in the memory 38 of the circuit module 30 is to be updated.

The computing system 12 is connected to port 2 of the switch 16 through an interface bridge 14. The computing system 12 can connect to the interface bridge 14 through a variety of interfaces such as USB, IEEE 1394, PCI, etc. Likewise, the switch 16 can connect to the interface bridge 14, the download connector 18, and the circuit module 30 through a variety of interfaces such as an RS-232 serial connection, a parallel connection, or any other suitable bus connection.

The circuit module 30 contains a power on pin 26 for turning on power of the circuit module 30. When the circuit module 30 is powered on, a control circuit 32 of the circuit module 30 causes the circuit module 30 to enter a reset mode for a predetermined period of time that is measured by a timing circuit 34. While the circuit module 30 is in the reset mode, the GPIO pin 24 acts as an input pin. In order to give the GPIO pin 24 a digital logic value while the GPIO pin 24 is acting as an input, a pull-down resistor RI is connected to the GPIO pin 24 for pulling the digital logic value of the GPIO pin 24 down to a value of “0” while the circuit module 30 is in the reset mode. The GPIO pin 24 having a value of “0” causes the switch 16 to connect the circuit module 30 to the download connector 18. If the cable 20 of the update module 22 is already connected to the download connector 18 when the circuit module 30 is powered on, or is plugged in soon after, the update module 22 will begin transferring the updated firmware to the memory 38 of the circuit module 30. An update monitoring circuit 36 will monitor the status of the firmware update to detect when the update is complete. As soon as the update monitoring circuit 36 detects that the update is complete, the update module 22 informs the control circuit 32. The control circuit 32 then switches the mode of the circuit module 30 from the reset mode to a normal operation mode.

On the other hand, if the cable 20 of the update module 22 is not connected to the download connector 18 or if the update process is not started, the circuit module 30 will automatically switch from the reset mode to the normal operation mode after the predetermined period of time counted by the timing circuit 34 is expired. As an example, the time period in which the circuit module 30 stays in the reset mode after being powered on can be five or ten seconds.

In either case, once the circuit module 30 is in the normal operation mode, the GPIO pin 24 becomes an output pin that outputs a digital logic value of “1” for connecting the circuit module 30 to the computing system 12. Thereafter, the circuit module 30 can communicate with the computing system 12 via the switch 16 and the interface bridge 14 for operating together with the computing system 12. The computing system 12 may be any kind of processor, digital signal processor, or even a complete system such as a desktop computer, notebook computer, or a personal digital assistant.

Of course, the digital logic used for controlling the operation of the switch 16 at port 1 can also be the reverse of what was described above. If that is the case, then a pull-up resistor can be used instead of the pull-down resistor RI. The digital logic values used above are only stated as examples, and are not limiting on the implementation of the present invention.

In summary, connecting the pull-down resistor RI to the GPIO pin 24 enables the GPIO pin 24 to be used for connection of the circuit module 30 between the computing system 12 and the update module 22 via the download connector 18. Therefore, in order to update the firmware stored in the memory 38 of the circuit module 30, the firmware can be downloaded into the circuit module 30 directly without first being transmitted through the computing system 12.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of updating a firmware of a circuit module, the method comprising:
providing a switch for selectively connecting the circuit module to a computing system and to an update module;
supplying power to the circuit module;
the circuit module entering a reset mode and an input/output pin of the circuit module switching to an input mode in response to power being supplied to the circuit module;
pulling the input/output pin to a first digital logic value;
the input/output pin controlling the switch to connect the circuit module to the update module in response to the input/output pin being pulled to the first digital logic value; and
the circuit module receiving an updated firmware from the update module while the circuit module is in the reset mode.

2. The method of claim 1 further comprising:
detecting the circuit module updating the firmware completely;
the circuit module entering a normal operation mode;
switching the input/output pin to an output mode for outputting a second digital logic value in response to the second digital logic value being the opposite of the first digital logic value.

3. The method of claim 2 further comprising:
controlling the switch to connect the circuit module to the computing system in response to the input/output pin outputting the second digital logic value.

4. The method of claim 2 wherein the first digital logic value is “0” and the second digital logic value is “1”, and pulling the input/output pin to the first digital logic value comprises attaching a pull-down resistor to the input/output pin for pulling the value of the input/output pin to “0” when the circuit module is in the reset mode.

5. The method of claim 2 wherein the first digital logic value is “1” and the second digital logic value is “0”, and pulling the input/output pin to the first digital logic value comprises attaching a pull-up resistor to the input/output pin for pulling the value of the input/output pin to “1” when the circuit module is in the reset mode.

6. The method of claim 1 wherein the input/output pin is a general purpose input/output (GPIO) pin.

7. The method of claim 1 wherein the circuit module enters the reset mode and the input/output pin of the circuit module switches to an input mode for a predetermined period of time in response to power being supplied to the circuit module.

8. The method of claim 7 further comprising the circuit module switching from the reset mode to the normal operation mode after the predetermined period of time has expired if the circuit module does not receive the updated firmware from the update module while the circuit module is in the reset mode.

9. The method of claim 1 wherein the circuit module is a global system for mobile communications/general packet radio service (GSM/GPRS) module.

10. The method of claim 1 wherein the circuit module communicates with the computing system and the update module through serial bus connections.

11. An updating system for updating a firmware of a circuit module from an update module, the circuit communicating with a computing system, the updating system comprising:
a switch for selectively connecting the circuit module to the computing system and to the update module;
a control circuit for causing the circuit module to enter a reset mode and causing an input/output pin of the circuit module to switch to an input mode in response to power being supplied to the circuit module; and
a resistor for pulling the input/output pin of the circuit module to a first digital logic value, thereby controlling the switch to connect the circuit module to the update module in order to receive the firmware from the update module while the circuit module is in the reset mode.

12. The updating system of claim 11 further comprising:
an update monitoring circuit for detecting the circuit module updating the firmware completely from the update module, the update monitoring circuit causing the circuit module to enter a normal operation mode and switching the input/output pin to an output mode for outputting a second digital logic value and controlling the switch to connect the circuit module to the computing system.

13. The updating system of claim 12 wherein the first digital logic value is “0” and the second digital logic value is “1”, and the resistor is a pull-down resistor for pulling the value of the input/output pin to “0” when the circuit module is in the reset mode.

14. The updating system of claim 12 wherein the first digital logic value is “1” and the second digital logic value is “0”, and the resistor is a pull-up resistor for pulling the value of the input/output pin to “1” when the circuit module is in the reset mode.

15. The updating system of claim 11 wherein the input/output pin is a general purpose input/output (GPIO) pin.

16. The updating system of claim 11 further comprising a timing circuit for causing the circuit module to enter the reset mode and the input/output pin to switch to the input mode for a predetermined period of time in response to power being supplied to the circuit module by a power supply.

17. The updating system of claim 16 wherein after expiration of the predetermined time counted by the timing circuit, the circuit module switches from the reset mode to the normal operation mode if the circuit module does not receive the firmware from the update module while the circuit module is in the reset mode.

18. The updating system of claim 11 wherein the circuit module is a global system for mobile communications/general packet radio service (GSM/GPRS) module.

19. The updating system of claim 111 wherein the circuit module communicates with the computing system and the update module through serial bus connections.
